(19) United States
(12) Patent Application Publication
(10) Pub. No.: US 2006/0157155 A1
(43) Pub. Date: Jul. 20, 2006

(54) Mini router and inlay assembly

(76) Inventor: Freddie E. Robinson, Dubberly, LA (US)

Correspondence Address: John M. Harrison, 2139 E. Bert Kouns, Shreveport, LA, 71105, US

(21) Appl. No.: 11/328,206

(22) Filed: Jan. 9, 2006

Related U.S. Application Data
(60) Provisional application No. 60/644,755, filed on Jan. 19, 2005.

(51) Int. Cl. B27C 5/10; B23C 1/20

(52) U.S. Cl. 144/136.95; 409/182

(57) ABSTRACT

A mini router for cutting shaped grooves in workstock is characterized in a first preferred embodiment by a router frame for receiving the bit chuck of a flexible shaft drilling and shaping tool, a pair of spring mounts slidably disposed in the frame in spaced-apart relationship with respect to each other, a base plate receiving one end of the spring mounts and a spring interposed on each of the spring mounts between the base plate and frame. A frame travel bracket is attached to the frame and receives an adjusting bolt for adjusting the travel of the frame and bit chuck downwardly against spring tension. A rotatable travel turret is mounted on a turret pedestal fixed to the base plate and includes one or more multi-planar adjusting pins for selectively contacting the adjusting bolt in the travel bracket when the frame is depressed. In a second preferred embodiment the mini router includes a pair of springs internally located in the respective spring mounts for achieving the same function as the external spring mini router. A “thicknesser” also includes a motor and bit combination mounted to a guide plate fitted with a base guide and guide springs that are spaced-apart to define an inlay travel gap. Elongated inlays can be extended through the inlay travel gap and engaged by the guide springs and bit to shape the inlays responsive to operation of the thicknesser motor. A tool positioning arm serves to suspend the tool over a workstock for optimum location of the mini router and a dial indicator is designed to engage the tool bit and determine the depth of an inlay groove to be cut in the workstock.

### CROSS-REFERENCE TO RELATED APPLICATIONS

This application claims the benefit of and incorporates by reference copending U.S. Provsional Application Ser. No. 60/644,755, Filed Jan. 19, 2005.

### SUMMARY OF THE INVENTION

This invention relates to routers and more particularly, to external spring and internal spring mini routers and accessory devices designed for use with a drilling and shaping tool and cutting inlay grooves of selected shape, width and depth for receiving inlays of corresponding size and shape. The external spring mini router is typically characterized by a router frame fitted with a pair of spaced-apart spring mounts, each end of which spring mounts engages an underlying base plate. The router housing receives and removably mounts the bit chuck of a flexible shaft drilling and shaping tool such as a dremel tool and is slidably mounted on the spring mounts. A spring is interposed between the router frame and the base plate on each of the spring mounts to facilitate depression of the router frame and the bit chuck toward the base plate while tensioning the springs. A frame travel bracket is attached to the router frame for mounting the bit chuck and receives a travel bracket adjusting bolt which is adjustably mounted in the frame travel bracket. A rotatable frame travel turret is positioned beneath the frame travel bracket and is mounted on a turret pedestal fixed to the base plate and fitted with one or more radially positioned, multi-planar travel adjusting pins. The travel adjusting pins contact the travel bracket adjusting bolt at selected levels and facilitate depression of the frame, bit chuck and a tool bit carried by the bit chuck, through a bushing located in the base plate, to a selected depth below the base plate. The tool bit is typically attached to the bit chuck mounted on the flexible shaft, such that the external spring mini router can be operated to cut slots, trenches or grooves of selected depth, width and shape in a workstock such as a board, to accommodate an inlay of corresponding size and shape.

In another preferred embodiment of the invention an internal spring mini router is provided wherein the router springs are located internally of the spring mounts, rather than externally thereof, as in the external spring mini router described above. In both the external spring mini router and the internal spring mini router a conventional bit chuck and flexible shaft dremel tool are typically utilized for creating the desired slots, cuts and grooves in a typically wooden workstock.

In yet another preferred embodiment of the invention a tool positioning arm is utilized to receive and mount the motor unit of the dremel tool and typically includes an arm frame fitted with an internal carriage pipe having a carriage that rides linearly and horizontally on the carriage pipe by means of a carriage pulley that suspends the dremel tool motor unit. The arm frame is typically rotatably attached to a support at a selected height such that the dremel tool and flexible shaft extending from the dremel tool, along with the bit chuck and bit of the dremel tool, can be suspended from the tool positioning arm and located in a precise position over a work area. This positioning of the dremel tool facilitates easy attachment of the bit chuck to the frame of the external spring mini router or internal spring mini router of this invention, as desired. Accordingly, the arm frame of the tool positioning arm can be rotated into a desired position over the mini router and the carriage moved along the tool positioning arm on the carriage pipe to facilitate a precise adjustment of the chuck and bit of the dremel tool in a selected mini router.

In another preferred embodiment of the invention, a “thicknesser” is designed to shape an elongated inlay to a desired thickness, and bevel, if desired. The “thicknesser” includes a thicknesser motor having a bit and attached to a guide plate having a removable base guide and companion springs adjustably secured thereto to create an inlay travel gap or area at the bit for receiving the inlay. The base guide edge is typically square or it may be bevelled at a selected angle, and the companion springs serve to bias the inlay against the edge of the base guide in alignment with the bit. Accordingly, the inlay may be cut square or it may be bevelled by operation of the bit when the inlay is extended through the inlay travel gap or area against the edge of the base guide.

In still another embodiment of the invention a dial indicator is provided and has an indicator fork fitted with fork legs, between which extends a piston. The legs of the indicator fork are designed to be placed on the bottom of the base plate of either the external spring mini router or the internal spring mini router and the piston then positioned to contact the end of the dremel bit extending from the dremel chuck in the dremel tool and facilitate precise measurement and adjustment of the dremel bit extension from the base plate, to create a groove or cut of selected depth in a workstock.

### BRIEF DESCRIPTION OF THE DRAWINGS

The invention will be better understood by reference to the accompanying drawings, wherein:

FIG. 1 is a perspective view of an external spring mini router in a typical functional position on a workstock, pressed against a template in a first operating configuration and receiving and clamping the bit chuck on the flexible shaft of a conventional dremel tool;

FIG. 2 is a perspective view of a workstock and an inlay fitted in a groove cut in the workstock by operation of the external spring mini router illustrated in FIG. 1;

FIG. 3 is a front perspective view of the external spring mini router illustrated in FIG. 1;

FIG. 4 is a rear perspective view of the external spring mini router illustrated in FIGS. 1 and 3;

FIG. 5 is a right side elevation of the external spring mini router illustrated in FIG. 3;

FIG. 6 is an exploded view of the external spring mini router illustrated in FIGS. 1 and 3-5;

FIG. 7 is a rear perspective view of an internal spring mini router of this invention;

FIG. 8 is a sectional view taken along line 8-8 of a spring mount element of the internal spring mini router illustrated in FIG. 7;

FIG. 9 is a perspective view of a dial indicator utilized to determine the depth of penetration of a dremel tool bit in a workstock, which bit is positioned in the bit chuck of the flexible shaft dremel tool and mounted in either the external spring mini router or internal spring mini router of this invention;

FIG. 10 is a front elevation of the dial indicator illustrated in FIG. 9 in functional application;

FIG. 11 is a perspective view of an inlay accessory or thicknesser device for shaping an elongated inlay to desired dimensions and providing an optional bevel for insertion of the inlay in the groove of a workstock;

FIG. 12 is a sectional view taken along line 12-12 of the thicknesser device illustrated in FIG. 11, more particularly illustrating a non-bevelled guide plate element;

FIG. 13 is a sectional view taken along line 12-12 of the thicknesser illustrated in FIG. 11, more particularly illustrating a bevelled guide plate element;

FIG. 14 is a rear perspective view of an adjustable dremel tool positioning arm for mounting and positioning the dremel tool motor assembly and the flexible shaft and bit chuck for attachment to and operation of a mini router;

FIG. 15 is a front perspective view of the adjustable dremel tool positioning arm illustrated in FIG. 14; and

FIG. 16 is a front elevation of the adjustable dremel tool positioning arm illustrated in FIGS. 14 and 15.

### DESCRIPTION OF THE PREFERRED EMBODIMENTS

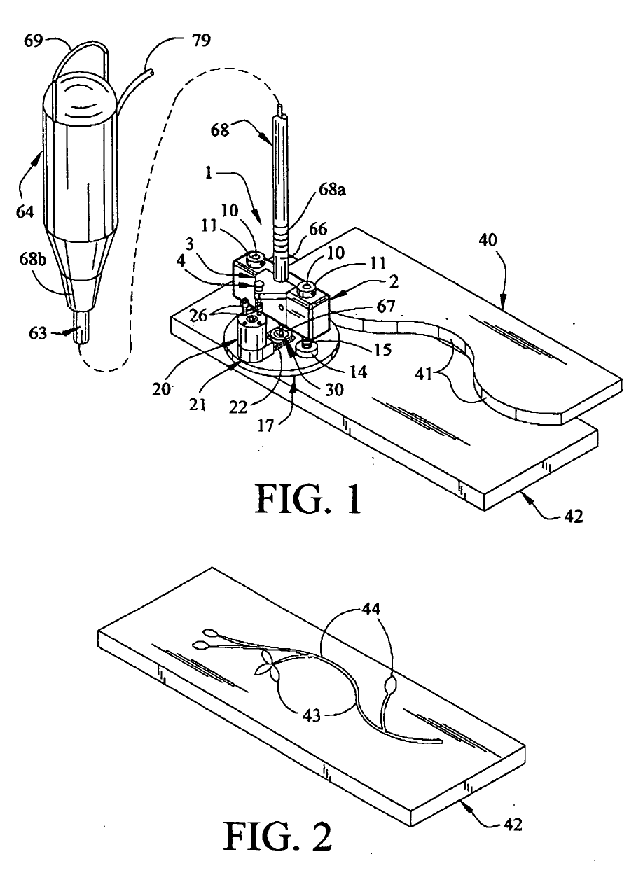

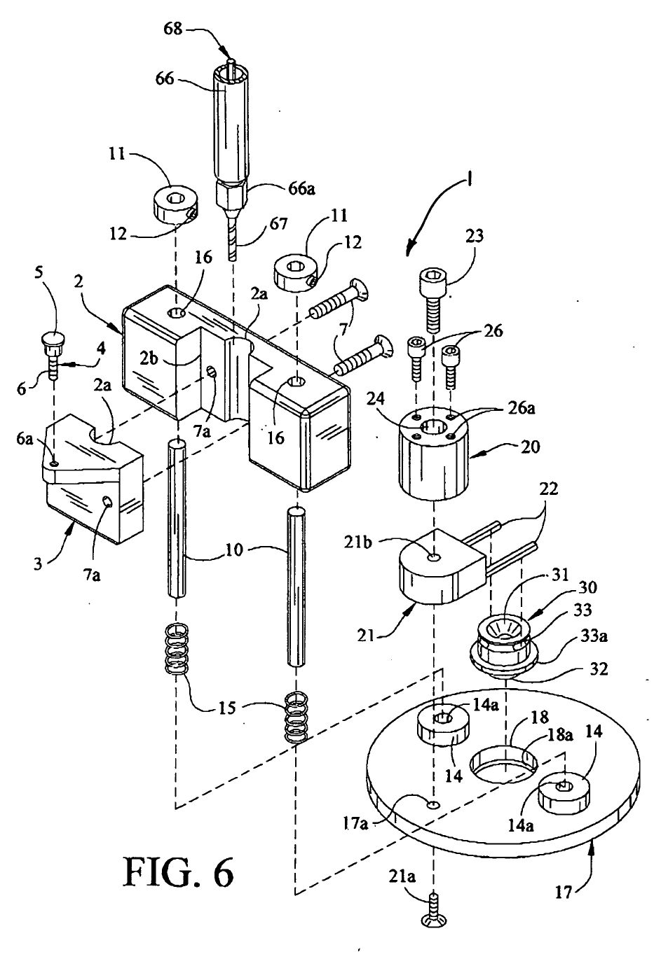

Referring now to FIGS. 1 and 3-6 of the drawings, in a first preferred embodiment of the invention, an external spring mini router is generally illustrated by reference numeral 1. The external spring mini router 1 includes a router frame 2, having a bit chuck mount opening 2a and a travel bracket mount slot 2b and fitted with a frame travel bracket 3, having a travel bracket adjusting bolt 4 adjustably and threadably mounted therein. The frame travel bracket 3 is removably seated in the travel bracket mount slot 2b and the travel adjusting bolt 4 includes an adjusting bolt head 5 and adjusting bolt threads 6 for adjustably seating in the threaded adjusting bolt seat 6a in the frame travel bracket 3 (FIG. 6) and positioning the adjusting bolt head 5 and adjusting bolt threads 6 vertically with respect to the router frame 2 by threadable adjustment of the adjusting bolt nut 6, as hereinafter further described. The frame travel bracket 3 is typically attached to the router frame 2 by a pair of travel bracket mount bolts 7, seated in companion travel bracket mount bolt openings 7a, as illustrated in FIGS. 4 and 6. A pair of spring mounts 10 are disposed in vertical, parallel, spaced-apart relationship with respect to each other and slidably receive the router frame 2 in spring mount openings 16, respectively, and are typically secured in place on the top of the router frame 2 by means of corresponding spring mount collars 11 (FIG. 6). A pair of allen screws 12 typically thread into correspondingly threaded openings (not illustrated) in the spring mount collars 11 to removably secure the spring mount collars 11 on the top ends of the spring mounts 10, as further illustrated in FIG. 6. A base plate 17 is positioned beneath the router frame 2 and includes a pair of spring mount discs 14, provided in alignment with and having disc seats 14a, respectively, (FIG. 6), for tightly receiving the bottom end of each of the respective spring mounts 10, and seating the spring mounts 10 in a corresponding spring mount base 14. A spring 15 is provided on each of the spring mounts 10 between the router frame 2 and a corresponding spring base 14, to facilitate downward depression of the router frame 2 on the spring mounts 10 against the bias in the springs 15, for purposes which will be hereinafter further described.

A bushing seat 18 has a seat undercut 18a (FIG. 6) and is provided in the base plate 17 between the spring mounts 10, for receiving a bushing 30, having a bevelled bushing opening 31 of selected size and a downwardly-protruding bushing nipple 32, to receive a bit 67 of corresponding size, attached to a bit chuck 66, provided in the flexible shaft 68 of a drilling and shaping tool such as a dremel tool 64, illustrated in FIG. 1. In a preferred embodiment the bushing 30 has a bushing shoulder 33a that seats in the seat undercut 18a when the bushing 30 is inserted in the bushing seat 18 from the bottom of the base plate 17. A bushing groove 33 is also provided in the bushing 30 and the bushing 30 is removably secured in place on the base plate 17 by a pair of bushing retainers 22 that extend in spaced-apart relationship with respect to each other from a turret pedestal 21, to removably engage the bushing groove 33 and secure the bushing 30 in place by spring tension. Accordingly, it will be appreciated by those skilled in the art that the bushing 30 can be inserted in and removed from its position in the bushing seat 18 against the seat undercut 18a between the bushing retainers 22, by finger pressure.

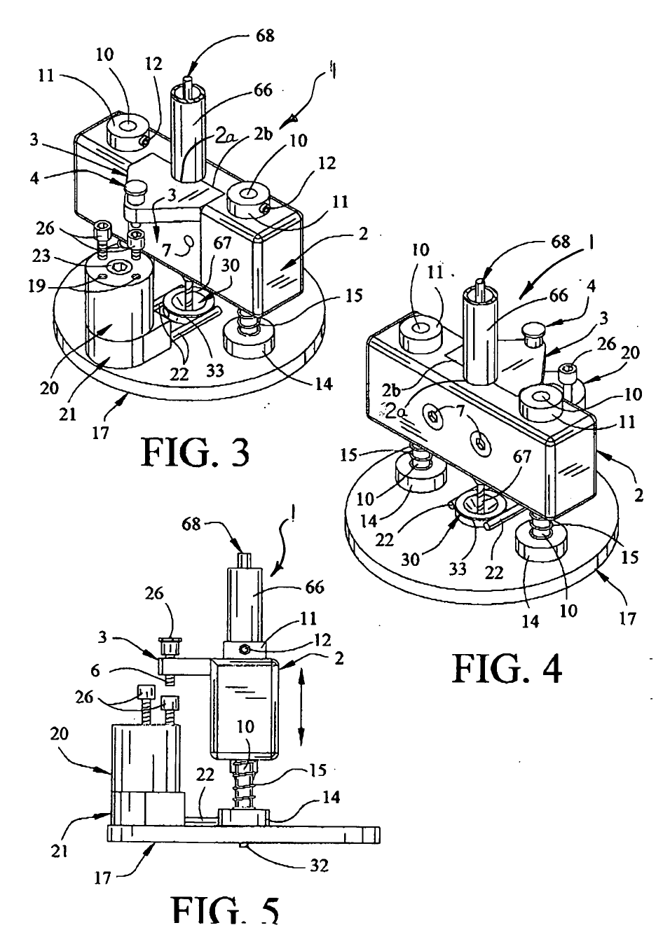

As further illustrated in FIGS. 1 and 3-6, a turret pedestal 21 is typically secured to the base plate 17 by any convenient means, such as one or more pedestal mount bolts 21a, illustrated in FIG. 6, extending through a pedestal mount opening or openings 17a in the base plate 17 (FIG. 6), into a threaded pedestal mount bolt opening 21b. The turret pedestal 21 supports a rotatable frame travel turret 20, as further illustrated in FIGS. 1 and 3-6 of the drawings. The frame travel turret 20 is rotatably mounted on the turret pedestal 21 by means of a turret mount bolt 23, extending through a turret mount bolt opening 24 into the threaded pedestal mount bolt opening 21b. An internal turret spring and corresponding turret ball fitted in a turret spring seat (not illustrated), typically facilitates this incremental rotation. A pair of travel adjusting pins 26 are typically threaded in corresponding pin openings 26a in the top face of the frame travel turret 20 and may be adjusted for height with respect to the frame travel turret 20. The travel adjusting pins 26 are designed to selectively vertically align with the bottom end of the adjusting bolt threads 6 of the travel bracket adjusting bolt 4 illustrated in FIGS. 1 and 3, responsive to incremental rotation of the frame travel turret 20, to determine a selected depth of penetration of the bit 67 into a substrate, as the bit 67 projects through the tapered bushing opening 31 of the bushing 30. As illustrated in FIG. 5 of the drawings, the bushing nipple 32 extends from the bushing 30 below the plane of the bottom of the base plate 17, to facilitate contact with the shaped edge 41 of a template 40, clamped or otherwise attached to a workstock 42 (FIG. 1) to be cut, in an alternative cutting configuration to the set-up illustrated in FIG. 1, as hereinafter further described.

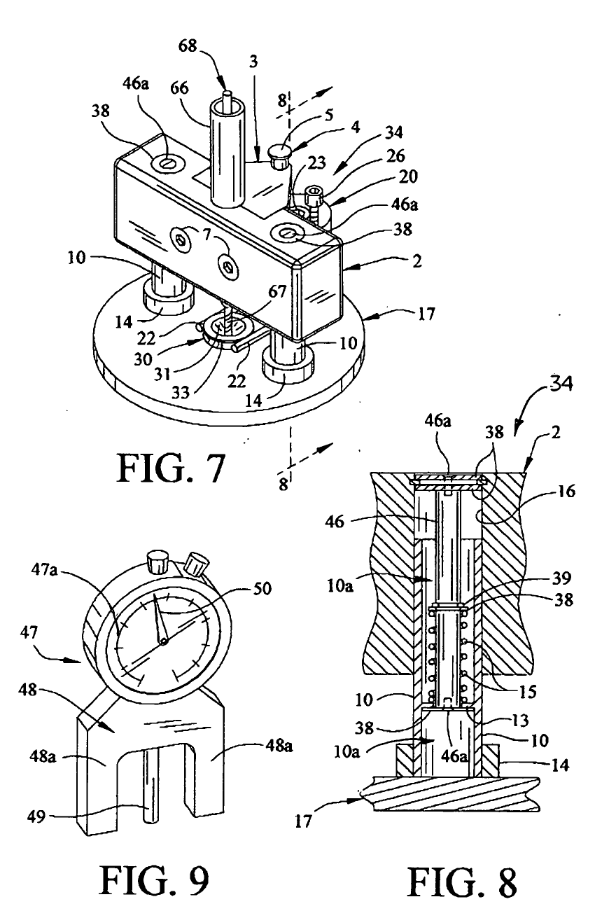

Referring now to FIGS. 7 and 8 of the drawings, an internal spring mini router 34 is illustrated and also includes a router frame 2, having a frame travel bracket 3 removably mounted thereon by means of the travel bracket mount bolts 7. The spring mounts 10 of the internal spring mini router 34 are hollow and are designed to receive a pair of brass rods 46, respectively, that project through the corresponding spring mount bore 10a provided in the spring mounts 10 (FIG. 8). The springs 15 are located inside the spring mount bore 10a of each spring mount 10, respectively, interposed between a shoulder 13 and a washer 38, mounted on each of the brass rods 46, respectively, by a corresponding snap ring 39. This design facilitates depression of the router frame 2 downwardly against spring tension toward the base plate 17, as in the case of the external spring mini router 1 illustrated in FIG. 1. A pair of rod mount bolts 46a seat a corresponding set of washers 38 on each end of the brass rods 46, respectively, as further illustrated in FIG. 8.

As further illustrated in FIGS. 1 and 2 of the drawings, the template 40 is illustrated, having a shaped edge 41 to facilitate cutting a correspondingly-shaped path or groove 43 in a workstock 42 for receiving an inlay 44 of corresponding shape (FIG. 2). The inlay 44 may be square or rectangular in cross-section or it may have an inlay bevel (not illustrated) to more easily insert the inlay 44 in the groove 43 provided in the workstock 42, as illustrated in FIG. 2 and hereinafter further described. As illustrated in FIG. 1, the template 40 may be clamped or otherwise attached to the underlying workstock 42 and a pilot hole (not illustrated) initially drilled in the workstock 42 at a desired beginning point to receive the bit 67 and the dremel tool 64 is then operated to rotate the bit 67 at the end of the flexible shaft 68 and cut the desired groove 43 illustrated in FIG. 2 of the drawings. The inlay 44 can then be tightly fitted in the groove 43, as further illustrated in FIG. 2.

In an alternative operating configuration, the external spring mini router 1 can be positioned as illustrated in FIG. 1, but with the bushing nipple 32 (FIG. 6) extending from the bottom of the bushing 30, aligned with and placed against the shaped edge 41 of the template 40, instead of the curved edge of the base plate 17. The pilot hole (not illustrated) can then be drilled in the underlying workstock 42 and the bit 67 extended through the pilot hole. The external spring mini router 1 can then be operated as described above to trace the shaped edge 41 of the template 40 with the bushing nipple 32 and cut a corresponding groove 43 in the workstock 42. The inlay 44 can then be fitted in the groove 43 as described above.

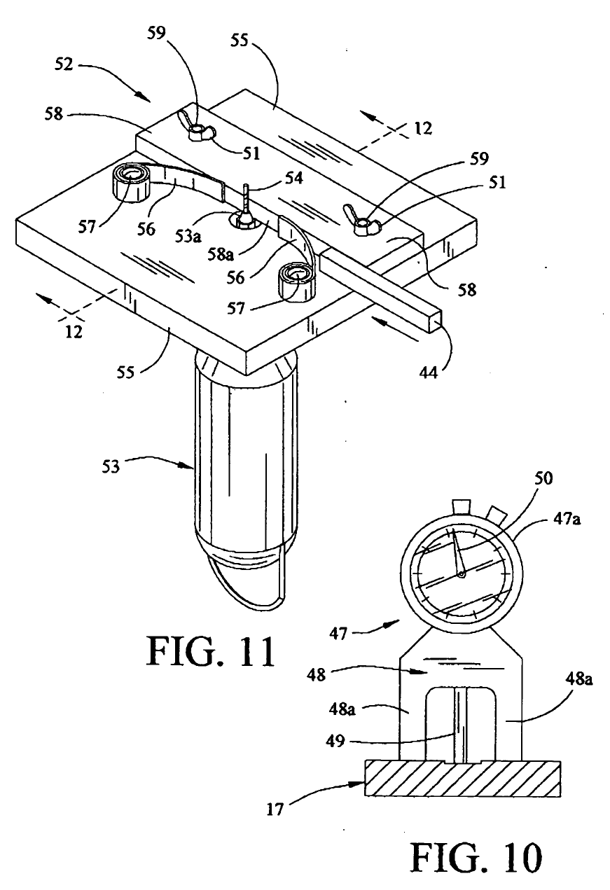

Referring now to FIGS. 9 and 10 of the drawings in another preferred embodiment of the invention a dial indicator 47 is provided in order to determine the depth of the groove 43 to be applied to the workstock 42 pursuant to operation of the external spring mini router 1 and internal spring mini router 34, respectively. The dial indicator 47 includes a dial 47a having an indicator needle 50 which rotates in the dial 47a against a scale responsive to depression of the indicator piston 49, extending between a pair of forked legs 48a, in an indicator fork 48. Accordingly, the dial indicator 47 can be positioned against the bottom of the base plate 17 in either the external spring mini router 1 or the internal spring mini router 34 as illustrated in FIG. 10, with the extending end of the indicator piston 49 touching the end of the bit 67 (not illustrated). The bit 67 can then be adjusted accordingly in the bit chuck mount openings 2a of the router frame 2 of the external spring mini router 1 or the internal spring mini router 34, by alternately loosening and tightening the corresponding travel bracket mount bolts 7. This adjustment facilitates determination of the exact depth of penetration of the bit 67 in the workstock 42 to define a groove 43 of selected depth, responsive to the indicated depth shown by the indicator needle 50 on the scale in the dial 47a of the dial indicator 47.

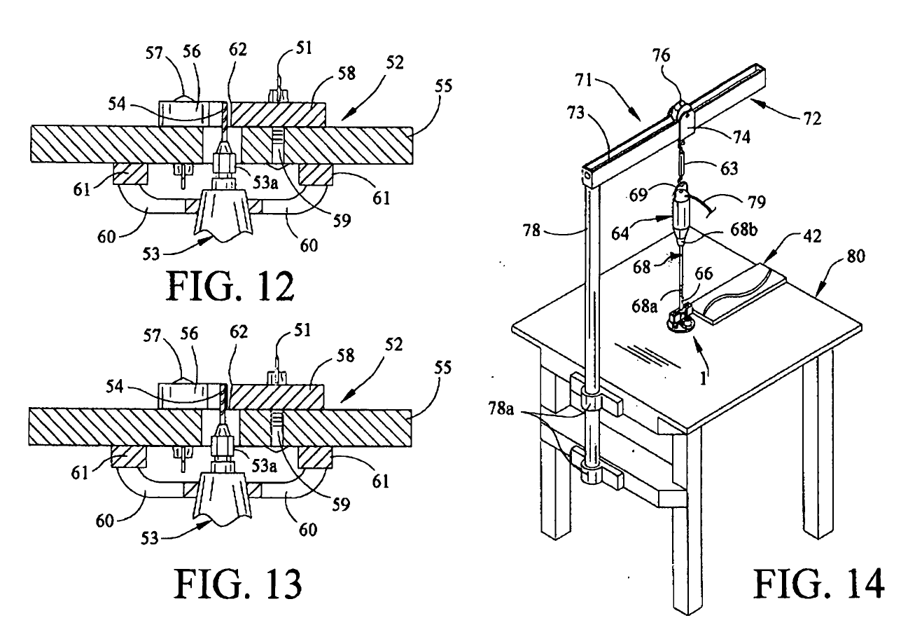

Referring now to FIGS. 11-13 of the drawings, a thicknesser 52 is provided for cutting a selected inlay (not illustrated) to a desired thickness and shape for insertion in a corresponding groove 43 cut by the external spring mini router 1 or the internal spring mini router 34, as described above. The thicknesser 52 includes a thicknesser base 55 fitted with a guide plate 58 that is removably attached to the thicknesser base 55 by means of guide plate mount bolts 59 and corresponding wing nuts 51. A pair of guide springs 56 are each mounted on a corresponding guide spring mount 57 to the thicknesser base 55 and serve to bias an inlay, which is extended along the facing plate edge 58a of the guide plate 58 in the direction of the arrow, against the bias of the respective guide springs 56, illustrated in FIG. 11. Accordingly, as further illustrated in FIGS. 11-13, an inlay can be cut to a square cross-section using a guide plate 58 having a square plate edge 58a (FIG. 12) or to a bevelled cross-section by using a guide plate 58 having a plate edge 58a which has a bevel of selected angle (FIG. 13) to facilitate greater ease in fitting the inlay into the groove 43 cut in the workstock 42 (FIG. 2). A pair of motor mounts 60 serve to typically mount the thicknesser motor 53 to the thicknesser base 55 by means of corresponding motor mount blocks 61. As further illustrated in FIGS. 11-13 of the drawings, in use, an inlay (not illustrated) is pressed against the plate edge 58a of the guide plate 58 and advanced in the direction of the arrow between the respective guide springs 56, through an inlay travel gap 62 (FIGS. 12 and 13)for engagement with the thicknesser cutter bit 54, to effect the desired shaping of the inlay.

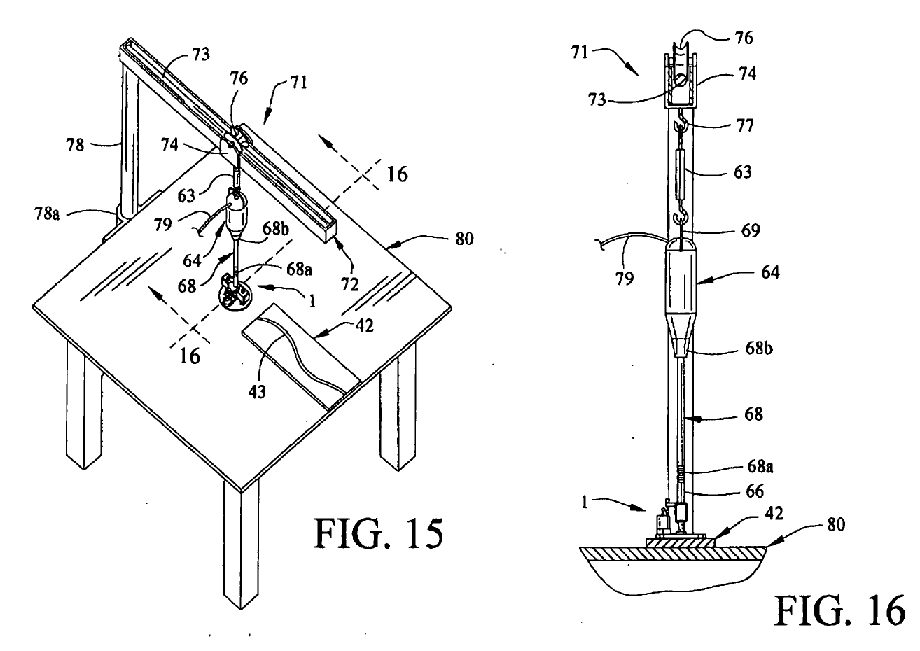

Referring to FIGS. 14-16 of the drawings in another preferred embodiment of the invention a tool positioning arm 71 is illustrated, wherein the motor housing of the dremel tool 64 is suspended by means of a suspension clip 69, directly or indirectly from the carriage hook 77 of a carriage 74, having a carriage pulley 76 which travels on a carriage pipe 73, mounted in a horizontal arm frame 72. The arm frame 72 is typically suspended at one end to a vertical frame support 78 that is bolted or otherwise attached to a mount table or bench 80, typically by means of support collars 78a. An electrical cord 79 extends from the dremel tool 64 for applying power to the dremel tool 64 in conventional fashion. The flexible shaft 68 extends from the suspended motor end of the dremel tool 64 downwardly and may include a shaft spring 68a at the lower end thereof, above the point where the bit chuck 66 (FIG. 6) engages an external spring mini router 1 or an internal spring mini router 34, as desired. Accordingly, suspending the dremel tool 64 in the manner illustrated in FIGS. 14-16 facilitates exact positioning of the dremel tool 64 and the flexible shaft 68, as well as the external spring mini router 1 or the internal spring mini router 34, over a workstock 42 which may be clamped or otherwise attached to the top of the mount table or bench 80. In the alternative, the dremel tool 64 can be suspended from a turnbuckle 63, connected to the carriage hook 77, as further illustrated in FIGS. 14-16, to facilitate height adjustment of the dremel tool 64. Alternatively, the frame support 78 can be provided with a threaded or telescoping vertical adjustment, or the frame support 78 can be vertically adjusted in the support collars 78a, according to the knowledge of those skilled in the art.

It will be recognized and appreciated by those skilled in the art that either the external spring mini router 1 or the internal spring mini router 34 can be fitted with a bushing 30 having a bushing opening 31 of selected size, as well as a bushing nipple 32 of corresponding size to accommodate a bit 67 of selected size for cutting a groove 43 of selected depth, width and shape in a workstock 42 using a suitable template 40. The external spring mini router 1 and internal spring mini router 34 can be both utilized, typically with the tool positioning arms 71 illustrated in FIGS. 12-14, as well as the dial indicator 47 illustrated in FIGS. 9 and 10 and the thicknesser illustrated in FIGS. 11-13, to effect a groove 43 of pre-selected dimension, shape and thickness in a workstock 42, which tightly accepts a correspondingly-shaped inlay 44, according to the procedures of this invention. It will be further recognized and understood that any desired cutting and shaping tool having a flexible shaft can be utilized with the external spring mini router 1 and internal spring mini router 34, although the dremel tool 64 illustrated in the drawings is preferred.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A mini router for receiving the bit chuck on the flexible shaft of a drilling tool and cutting a groove of selected depth, width and shape in a workstock, said mini router comprising a base; at least two spring mounts extending from said base; a frame slidably disposed on said spring mounts; bias means interposed between said frame and said base for urging said frame away from said base; and engaging means provided on said frame for receiving the bit chuck of the drilling tool and cutting the groove responsive to depression of said frame against said bias means, operation of the drilling tool and manipulation of said frame along the workstock.

2. The mini router of claim 1 wherein said bias means comprises a coil spring provided on each of said spring mounts for said urging said frame away from said base.

3. The mini router of claim 1 wherein said engaging means comprises a frame groove provided in said frame, a travel bracket carried by said frame and a bracket groove provided in said travel bracket for matching said frame groove and receiving the flexible shaft in said frame groove and said bracket groove.

4. The mini router of claim 1 wherein:
(a) said bias means comprises a coil spring provided on each of said spring mounts for said urging said frame away from said base; and
(b) said engaging means comprises a frame groove provided in said frame, a travel bracket carried by said frame and a bracket groove provided in said travel bracket for matching said frame groove and receiving the flexible shaft in said frame groove and said bracket groove.

5. The mini router of claim 3 comprising an adjusting member carried by said travel bracket, a turret rotatably carried by said base and at least one adjusting pin provided in said turret, said adjusting pin selectively vertically aligned with said adjusting member responsive to rotation of said turret on said base, for limiting the travel of said frame and said travel bracket toward said base against the bias of said bias means responsive to said depression of said frame against said bias means.

6. The mini router of claim 5 wherein said bias means comprises a coil spring provided on each of said spring mounts for said urging said frame away from said base.

7. The mini router of claim 1 wherein a template is fastened to the workstock and comprising a bushing seat provided in said base and a bushing seated in said bushing seat for receiving a bit provided in the bit chuck of the flexible shaft and a bushing nipple projecting from said bushing beyond the plane of said base for guiding said mini router along the template.

8. The mini router of claim 7 wherein said bias means comprises a coil spring provided on each of said spring mounts for said urging said frame away from said base.

9. The mini router of claim 8 wherein said engaging means comprises a frame groove provided in said frame, a travel bracket carried by said frame and a bracket groove provided in said travel bracket for matching said frame groove and receiving the flexible shaft in said frame groove and said bracket groove.

10. The mini router of claim 9 comprising an adjusting member carried by said travel bracket, a turret rotatably carried by said base and at least one adjusting pin provided in said turret, said adjusting pin selectively vertically aligned with said adjusting member responsive to rotation of said turret on said base, for limiting the travel of said frame and said travel bracket toward said base against the bias of said bias means responsive to said depression of said frame against said bias means.

11. The mini router of claim 1 wherein said bias means comprises a coil spring provided inside each of said spring mounts for urging said frame away from said base.

12. The mini router of claim 11 wherein said engaging means comprises a frame groove provided in said frame, a travel bracket carried by said frame and a bracket groove provided in said travel bracket for matching said frame groove and receiving the flexible shaft in said frame groove and said bracket groove.

13. The mini router of claim 12 comprising an adjusting member carried by said travel bracket, a turret rotatably carried by said base and at least one adjusting pin provided in said turret, said adjusting pin selectively vertically aligned with said adjusting member responsive to rotation of said turret on said base, for limiting the travel of said frame and said travel bracket toward said base against the bias of said bias means responsive to said depression of said frame against said bias means.

14. A mini router for receiving the bit chuck on the flexible shaft of a drilling tool and cutting a groove of selected depth, width and shape in a workstock, said mini router comprising a base; at least two spring mounts extending from said base; a frame slidably disposed on said spring mounts; bias means interposed between said frame and said base for urging said frame away from said base; and engaging means provided on said frame for receiving the bit chuck of the drilling tool and cutting the groove responsive to depression of said frame against said bias means, operation of the drilling tool and manipulation of said frame along the workstock.
